(19) United States
(12) Patent Application Publication
(10) Pub. No.: US 2012/0057180 A1
(43) Pub. Date: Mar. 8, 2012

(54) Image forming apparatus and method for controlling the same

(75) Inventors: Byeong Jin Lee, Suwon-si (KR); Hyung Jong Kang, Seoul (KR); In Chang Park, Seoul (KR); Mi Sook Song, Suwon-si (KR); Hee Chul Jung, Suwon-si (KR)

(73) Assignee: SAMSUNG ELECTRONICS CO., LTD., Suwon-si (KR)

(21) Appl. No.: 13/137,653

(22) Filed: Aug. 31, 2011

(30) Foreign Application Priority Data
Sep. 6, 2010 (KR) 10-2010 0086788

(51) Int. Cl. G06K 15/02

(52) U.S. Cl. 358/1.13

(57) ABSTRACT

An image forming apparatus and a method for controlling the same are disclosed. The image forming apparatus includes an input unit to generate an administrator scan profile and establish a scan profile policy, and allows the administrator of the apparatus to apply a specific scan profile policy to all users sharing the apparatus using the input unit. The image forming apparatus includes an input unit to perform at least one of generation of a first scan profile and establishment of a scan profile policy, and a controller to perform a scanning operation according to at least one of the first scan profile and the scan profile policy.

### CROSS-REFERENCE TO RELATED APPLICATIONS

This application claims the priority benefit of Korean Patent Application No. 2010-0086788, filed on Sep. 6, 2010 in the Korean Intellectual Property Office, the disclosure of which is incorporated herein by reference.

### BACKGROUND

1. Field

Embodiments relate to an image forming apparatus, and more particularly to a multifunctional-peripheral-type image forming apparatus having a scanner or a scanning function.

2. Description of the Related Art

In general, an image forming apparatus has been widely used to print an image on a printing medium such as paper according to original image data. A variety of image forming apparatuses have been used, for example, a printer, a copier, a facsimile, etc. Such image forming apparatuses are coupled to mobile or portable devices capable of processing information, such as a personal computer (PC), a laptop, a Personal Digital Assistant (PDA), etc., thereby transmitting and receiving data to and from the mobile devices by wire or wirelessly.

For a household image forming apparatus, one image forming apparatus maybe coupled to one user computer through a Universal Serial Bus (“USB”) cable or parallel cable, etc., such that the user computer controls operations of the household image forming apparatus. For an office image forming apparatus, a plurality of users may share one image forming apparatus over a network. Since the application of a host computer controls generation and management of a scan profile, users of the image forming apparatus generate their own scan profiles in a network environment, and store the generated scan profiles in a computer, such that the scanning process can be conducted using the stored scan profiles.

However, according to the above-mentioned conventional image forming apparatus, it is very difficult for an administrator or manager of the conventional image forming apparatus to provide a desired specific scan profile policy to all users sharing the image forming apparatus.

### SUMMARY

According to an aspect of one or more embodiments, there is provided an image forming apparatus which includes an input unit to generate an administrator scan profile and to establish a scan profile policy, and which allows the administrator of the image forming apparatus to apply a specific scan profile policy to all users sharing the image forming apparatus using the input unit, as well as a method for controlling the same.

Additional aspects of one or more embodiments will be set forth in part in the description which follows and, in part, will be apparent from the description, or may be learned by practice of the invention.

In accordance with one aspect of one or more embodiments, an image forming apparatus includes an input unit to perform at least one of generation of a first scan profile and establishment of a scan profile policy, and a controller to perform a scanning operation according to at least one of the first scan profile and the scan profile policy.

The image forming apparatus may further include a display to display at least one allowed scan profile for a user according to the scan profile policy.

The image forming apparatus may further include a selection unit to select at least one of the at least one allowed scan profile displayed on the display.

The first scan profile may be an administrator scan profile.

The image forming apparatus may be connected to at least one user computer over a network.

The scan profile policy may include a scan profile policy for each user so as to provide different kinds of scan profiles according to authority assigned to each login ID.

The scan profile policy may provide one or both of a user scan profile and an administrator scan profile according to authority assigned to the login ID.

The scan profile policy may include a scan profile policy for each option, so as to provide different option values of the scan profile according to authority assigned to each login ID.

The image forming apparatus may support a Scan-To-PC scheme.

The input unit may include a plurality of keys.

The input unit may be implemented as a graphical user interface (GUI) displayed on a touch panel.

The input unit may be an Embedded Web Server (EWS).

In accordance with another aspect of one or more embodiments, a method for controlling an image forming apparatus which includes an input unit to perform at least one of generation of a first scan profile and establishment of a scan profile policy and a controller to perform a scanning operation according to at least one of the first scan profile and the scan profile policy, and is connected to at least one user computer over a network, includes determining whether a user logs in to the image forming apparatus, displaying, if the user logs in to the image forming apparatus, only a scan profile allowed for a login ID of the user, and upon receiving a signal for selecting at least one of scan profiles allowed for the login ID, performing a scanning process using the selected scan profile.

The scan profile allowed for the login ID may be determined according to the scan profile policy related to the login ID.

The scan profile policy may include a scan profile policy for each user so as to provide different kinds of scan profiles according to authority assigned to each login ID.

The scan profile policy may provide one or both of a user scan profile and an administrator scan profile according to authority assigned to the login ID.

The scan profile policy may include a scan profile policy for each option, so as to provide different option values of the scan profile according to authority assigned to each login ID.

The method may further include, upon receiving the signal for selecting the scan profile, transmitting the selected scan profile to a user computer coupled to the image forming apparatus, and receiving a scan request using the selected scan profile from the user computer.

The method may further include, after completion of the scanning process, transmitting the result of the scanning process to the user computer.

The first scan profile may be an administrator scan profile.

The image forming apparatus may support a Scan-To-PC scheme.

In accordance with another aspect of one or more embodiments, a method for controlling an image forming apparatus which includes an input unit to perform at least one of generation of a first scan profile and establishment of a scan profile policy and a controller to perform a scanning operation according to at least one of the first scan profile and the scan profile policy, and is connected to at least one user computer over a network, includes determining whether a user logs in to the image forming apparatus, receiving, if the user logs in to the image forming apparatus, a second scan profile from the user computer related to a login ID of the user, displaying only a scan profile allowed for the user login ID from the first scan profile and the second scan profile according to the scan profile policy, and upon receiving a signal for selecting at least one of scan profiles allowed for the login ID, performing a scanning process using the selected scan profile.

The scan profile policy may include a scan profile policy for each user so as to provide different kinds of scan profiles according to authority assigned to each login ID.

The scan profile policy may provide one or both of the first scan profile and the second scan profile according to authority assigned to the login ID.

The method may further include, upon receiving the signal for selecting the scan profile, transmitting the selected scan profile to a user computer coupled to the image forming apparatus, and receiving a scan request using the selected scan profile from the user computer.

The method may further include, after completion of the scanning process, transmitting the result of the scanning process to the user computer.

The first scan profile may be an administrator scan profile.

The second scan profile may be a user scan profile generated by the user computer.

The image forming apparatus may support a Scan-To-PC scheme.

In accordance with another aspect of one or more embodiments, a method for controlling an image forming apparatus which includes an input unit to perform at least one of generation of a first scan profile and establishment of a scan profile policy and a controller to perform a scanning operation according to at least one of the first scan profile and the scan profile policy, and is connected to at least one user computer over a network, includes determining whether a user logs in to the image forming apparatus, receiving, if the user logs in to the image forming apparatus, a second scan profile from the user computer related to a login ID of the user, generating a modified scan profile by reflecting the first scan profile and the scan profile policy to the second scan profile, displaying the modified scan profiles, and upon receiving a signal for selecting at least one of the modified scan profiles, performing a scanning process using the selected scan profile.

The scan profile policy may include a scan profile policy for each option, so as to provide different option values of the scan profile according to authority assigned to each login ID.

The method may further include, upon receiving the signal for selecting the scan profile, transmitting the selected scan profile to a user computer coupled to the image forming apparatus, and receiving a scan request using the selected scan profile from the user computer.

The method may further include, after completion of the scanning process, transmitting the result of the scanning process to the user computer.

The first scan profile may be an administrator scan profile.

The second scan profile may be a user scan profile generated by the user computer.

The image forming apparatus may support a Scan-To-PC scheme.

According to another aspect of one or more embodiments, there is provided at least one non-transitory computer readable medium storing computer readable instructions to implement methods of one or more embodiments.

### BRIEF DESCRIPTION OF THE DRAWINGS

These and/or other aspects of embodiments will become apparent and more readily appreciated from the following description of embodiments, taken in conjunction with the accompanying drawings of which:

FIG. 1 is a conceptual diagram illustrating network connection of an image forming apparatus according to an embodiment.

FIG. 2 is a conceptual diagram illustrating the image forming apparatus shown in FIG. 1 and constituent elements of each user computer according to an embodiment.

FIG. 3 is a conceptual diagram illustrating a user registration process of an image forming apparatus according to an embodiment.

FIG. 4 shows a scan profile policy for each user according to one embodiment.

FIG. 5 is a flowchart illustrating a method for selecting a scan profile dependent upon a user policy according to an embodiment.

FIG. 6 is a flowchart illustrating a scanning method based on a user policy according to an embodiment.

FIG. 7 is a flowchart illustrating another scanning method based on a user policy according to an embodiment.

FIG. 8 is a flowchart illustrating still another scanning method based on a user policy according to an embodiment.

FIG. 9 is a flowchart illustrating a scanning method according to an embodiment.

FIG. 10 is a conceptual diagram illustrating a method for generating a new modified scan profile by reflecting a scan profile policy for each option to a user scan profile according to an embodiment.

### DETAILED DESCRIPTION

Reference will now be made in detail to the embodiments, examples of which are illustrated in the accompanying drawings, wherein like reference numerals refer to like elements throughout.

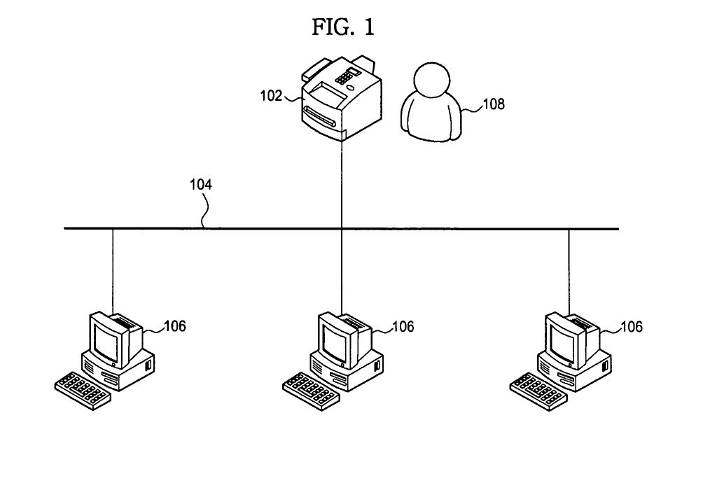

FIG. 1 is a conceptual diagram illustrating network connection of an image forming apparatus according to one embodiment. Referring to FIG. 1, the image forming apparatus 102 is connected to at least one user computer 106 over a network 104.

The image forming apparatus 102 is a multifunctional peripheral device having a scanner or a scanning function. The network 104 may correspond to a wired or wireless network on the assumption that data communication between the image forming apparatus 102 and at least one user computer 106 is achieved. For example, the user computer 106 may be a PC, a laptop, tablet, PDA, etc. Besides, the user computer 106 may be any device capable of operating the application for scanning.

The image forming apparatus 102 of FIG. 1 is based on a Scan-To-PC scheme in which operations needed for scanning and storing documents are performed in the image forming apparatus 102 instead of the PC 106 and the scanning result is stored in the user computer 106. Different from the general printing process, the scanning process is designed to insert a document to be scanned into a predetermined position of the image forming apparatus, and then generates a scanning command for the document. If the distance from the user computer to the image forming apparatus is relatively long, the user has to manually insert a document into the image forming apparatus, go back to his or her computer, enter a command to scan the document, go back to the image forming apparatus, and take the document out of the image forming apparatus, resulting in greater inconvenience of use. Therefore, assuming that the user who has moved to the image forming apparatus inserts a document into the image forming apparatus, enters a scanning command, and immediately takes the document out of the image forming apparatus without waiting for a predetermined time, it is expected that user convenience is very high. As described above, the user 108 obtains authority to use the image forming apparatus 102 through a user login process of the image forming apparatus 102, and conducts manipulation for the objective scanning, such that the scanning is executed. The scanning result is transmitted to the corresponding user computer 106 related to a login identification (Login ID) of the user 108, and is then stored in the user computer 106. If necessary, the final destination of the scanning result is changed in the image forming apparatus 102, so that the scanning result may also be transmitted to other user computers 106 unrelated to Login ID.

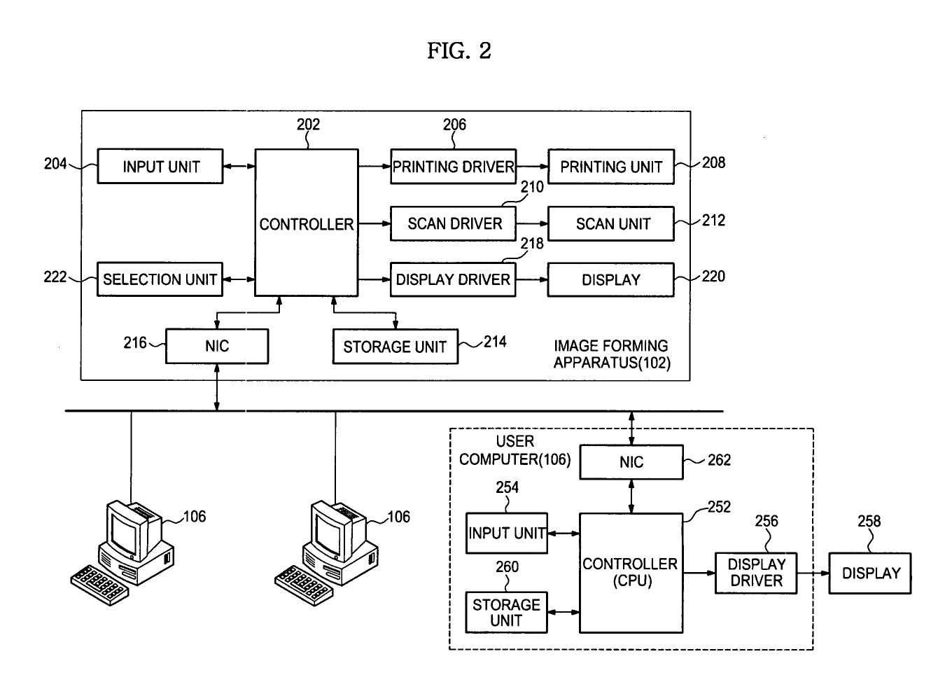

FIG. 2 is a conceptual diagram illustrating the image forming apparatus shown in FIG. 1 and constituent elements of each user computer according to an embodiment. Referring to FIG. 2, the image forming apparatus 102 includes a controller 202 to control overall operations of the image forming apparatus 102. The input unit 204 and the selection unit 222 are coupled to an input of the controller 202 so that they can communicate with the controller 202. A printing driver 206 coupled to a printing unit 208 is connected to the output of the controller 202 so that it can communicate with the controller 202. A scan driver 210 coupled to the scan unit 212 is connected to the output of the controller 202 so that it can communicate with the controller 202. A display driver 218 coupled to the display 220 is connected to the output of the controller 202 so that it can communicate with the controller 202. In addition, a storage unit 214 and a Network Interface Card (NIC) 216 are coupled to the controller 202.

The input unit 204 of the image forming apparatus 102 enables an administrator of the image forming apparatus 102 to generate an administrator scan profile and establish a scan profile policy, etc. For example, the input unit 204 may be implemented as a keypad and a plurality of keys (or buttons) including direction (arrow) keys and input keys. As another example, the input unit 204 may be implemented as a touch panel, etc. so that the user may directly enter data using the touch panel. The selection unit 222 may be used for the user of the image forming apparatus 202 to perform a login process, selection of a scan profile, etc. In the same manner as in the above-mentioned input unit 204, the selection unit 222 may also be implemented as a keypad and a plurality of keys (or buttons) including direction (arrow) keys, and input keys, etc. In addition, the selection unit 222 may also be implemented as a touch panel or the like, so that the user can directly enter data using the touch panel.

Although FIG. 2 exemplarily shows the input unit 204 and the selection unit 222 that are separated from each other, the input unit 204 and the selection unit 222 may also share a group of keypads, arrow buttons, input buttons, and the like. The display 220 is adapted to generate an administrator scan profile, establish a scan profile policy, and display information needed for performing user login and the scan profile selected by the user. Generally, the display 220 may be implemented as a general LCD panel or a touch panel, etc. If the display 220 is implemented as a touch panel, the above-mentioned input unit 204 and the selection unit 222 may also be simultaneously implemented through a Graphical User Interface (GUI) menu displayed on the display 220. The storage unit 214 stores system software for operating the image forming apparatus 102, data for printing/scanning, and data generated during printing/scanning, etc. The network interface card 216 allows the controller 202 to communicate with another device over the network 104. An Embedded Web Server (EWS) may be used as another example of the input unit 204 of the image forming apparatus 102. EWS is a Web server embedded in a small-sized network device. In the case of using the EWS, the administrator can access the image forming apparatus 102 from anywhere at any time, such that the administrator scan profile can be generated and the scan profile can be established.

For example, the user computer 106 such as a PC enables a controller 252 corresponding to a Central Processing Unit (CPU) to control the overall operations of the user computer 106, and an input unit 254 can be coupled to an input of the controller 252 so that it can communicate with the controller 252. A display driver 256 coupled to a display 258 is coupled to the output of the controller 252. The storage unit 260 stores system software for operating the user computer 106 or data encountered in operating the user computer 106, etc. NIC 262 enables the controller 252 to communicate with another device over the network 104.

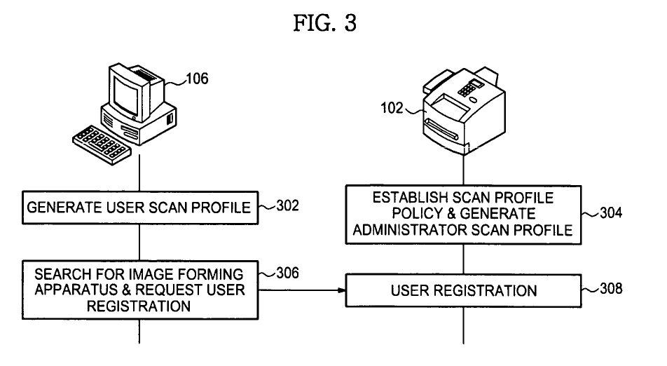

FIG. 3 is a conceptual diagram illustrating a user registration process of an image forming apparatus according to an embodiment. Referring to FIG. 3, if the user generates a user scan profile in the user computer 106, the user scan profile is stored in the storage unit 260 of the user computer 106 in operation 302. The user computer 106 can generate the user scan profile whenever a new user computer is added. In addition, the previously connected user computer may generate and add a new user scan profile, or may update the previously generated user scan profile. The user scan profile is provided when a user desired option value is assigned to each option of the scanning function provided from the image forming apparatus 102. In a subsequent process, the user scan profile having a necessary option value is selected and scanning of the selected scan profile is conducted. The user scan profile is generated by the user of the user computer 106.

If an administrator of the image forming apparatus 102 establishes the scan profile policy and the administrator scan profile is generated, the scan profile policy and the administrator scan profile are stored in the storage unit 214 of the image forming apparatus 102 in operation 304. The scan profile policy establishment and the administrator scan profile generation in the image forming apparatus 102 can also be conducted during initial installation process of the image forming apparatus 102. In addition, the conventional scan profile policy and the conventional administrator scan profile can be updated at any time after the installation of the image forming apparatus 102, or the new scan profile policy and the administrator scan profile can also be generated at any time after the installation of the image forming apparatus 102. The administrator scan profile is provided when an administrator-desired option value is assigned to each option of the scanning function provided from the image forming apparatus 102 according to the scan profile policy, such that if the user generates a scanning command in a subsequent process, scanning can be performed through either the user scan profile and the administrator scan profile or a combination thereof. According to the scan profile policy, if the scanning request is generated, the scan profile policy predefines how to perform the scanning process depending on the scan profile. Through the scan profile policy, the user can select a specific scan profile or apply a specific option for security or the like. The administrator scan profile is generated in the image forming apparatus 102 by the administrator.

If the user computer 106 completes generation and storage of the user scan profile, it searches for the image forming apparatus 102 connected over the network 104, and transmits a user registration request to the searched image forming apparatus 102 in operation 306. When the user registration request of the user computer 106 is generated, the IP address, the user login ID, etc. of the user computer are provided to the image forming apparatus 102. The IP address of the user computer 106 is used by the image forming apparatus 102 to identify each user computer 106. The login ID is adapted to enable the user to log in to the image forming apparatus 102.

Upon receiving the user registration request from the user computer 106, the image forming apparatus 102 stores the IP address, the login ID and the like of the corresponding user computer 106 in the storage unit 214, so that the stored information can be used to identify each user and each user computer 106 when the user logs in at a later time, resulting in completion of user registration in step 308.

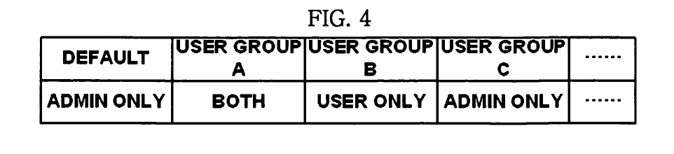

FIG. 4 shows a scan profile policy for each user according to an embodiment. Referring to FIG. 4, group classification is made at every user registered in the image forming apparatus 102, and individual user groups have different authorities by which each user group can access the scan profile. In FIG. 4, a user group A is denoted by “BOTH”, a user group B is denoted by “USER ONLY”, and a user group C is denoted by “ADMIN ONLY”. The above-mentioned classification is configured in the form of a table and then stored in the storage unit 214 of the image forming apparatus 102, so that the controller 202 may refer to the stored classification information.

Users of the user group denoted by “USER ONLY” can use only the user scan profile, and “USER ONLY” restricts user authority so that the corresponding user can use only the user scan profile. Users of the user group denoted by “ADMIN ONLY” can use only the administrator scan profile, and “ADMIN ONLY” further restricts user authority for enhanced security and the like. Users of the user group denoted by “BOTH” can use both the user scan profile and the administrator scan profile, and user authority is mitigated such that it is possible to freely use the user scan profile directly generated by the user and the administrator scan profile. In association with the above-mentioned description, if a user logs in to the image forming apparatus 102, only the list of allowed scan profiles for each group including the corresponding user is displayed so that the user can select a desired scan profile. As a result, the user basically restricts use of the disallowed scan profile.

Specifically, “ADMIN ONLY” forcibly commands the corresponding user to use only the administrator scan profile, such that users whose management is required for security can execute only the scan process to which the security is applied. For example, when a user of the user group denoted by “ADMIN ONLY” performs the scan process, a predetermined watermark or the like is inserted into the scan result, such that it can be recognized that the scan resultant is identical to the scan result executed by the user of the user group denoted by “ADMIN ONLY” in the corresponding image forming apparatus 102. As a result, “ADMIN ONLY” can restrict the disallowed scan, and trace the generation position of the scan result, thereby implementing high security.

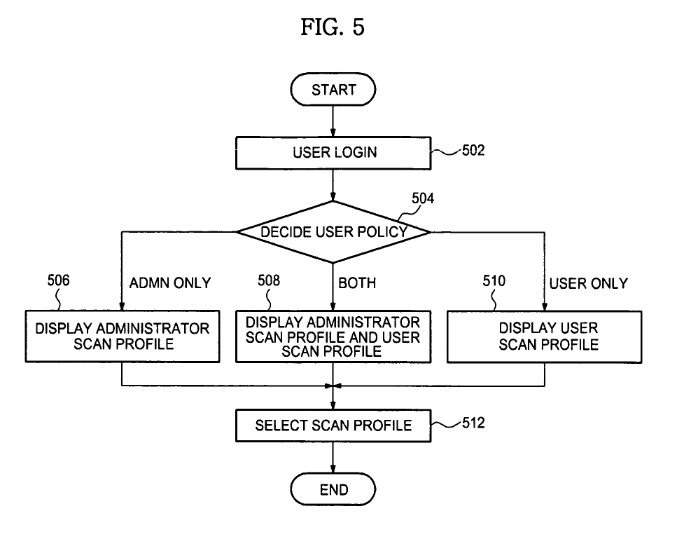

FIG. 5 is a flowchart illustrating a method for selecting a scan profile dependent upon a user policy according to an embodiment. Referring to FIG. 5, if a user logs in to the image forming apparatus 102 in operation 502, the controller 202 of the image forming apparatus 102 determines the user policy corresponding to the login user by referring to the user policy table in operation 504. If the user policy of the login user is set to “ADMIN ONLY”, the controller 202 of the image forming apparatus 102 displays only the administrator scan profile in operation 506. If the user policy of the login user is set to “BOTH”, the controller 202 of the image forming apparatus 102 displays both the administrator scan profile and the user scan profile in operation 508. If the user policy of the login user is set to “USER ONLY”, the controller 202 of the image forming apparatus 102 displays only the user scan profile in operation 510. The login user selects a scan profile appropriate for his or her purpose from a plurality of displayed scan profiles in operation 512.

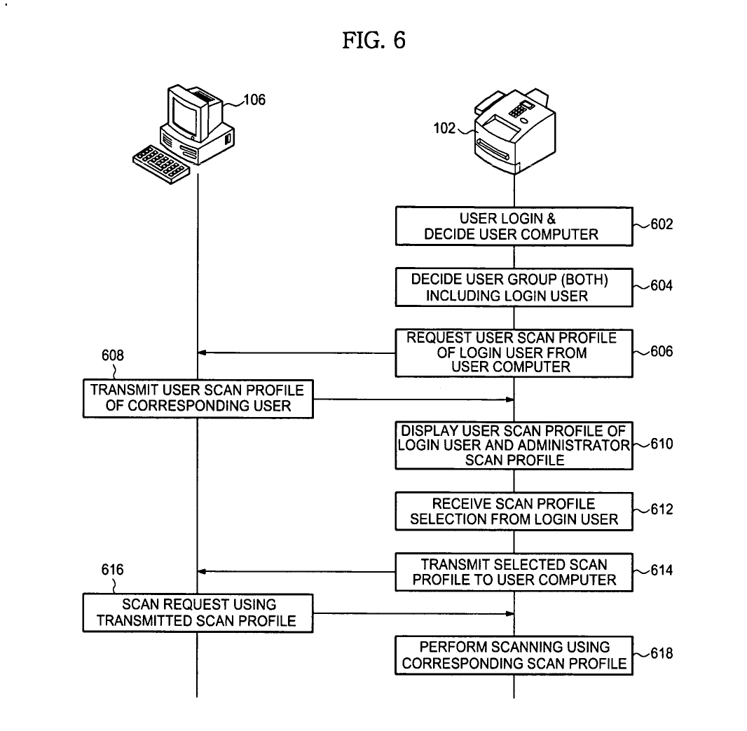

FIG. 6 is a flowchart illustrating a scanning method based on a user policy according to one embodiment. In more detail, FIG. 6 shows a scanning method executed in the image forming apparatus 102 upon receiving a request from the user in the user group denoted by “BOTH”. In FIG. 6, the user computer 106 stores at least one user scan profile, the image forming apparatus 102 stores at least one administrator scan profile, at least one user computer and at least one user are registered in the image forming apparatus 102, and a user group for the user is preset (See FIGS. 3 and 4). In order to enable the user to perform the scanning process using the image forming apparatus 102, the user has to log in to the image forming apparatus 102 through his or her login ID in operation 602. When the user logs in, the user determines a desired user computer 106 to which the scanning result is to be transmitted and stored. If the user does not determine a desired user computer, the user computer 106 related to an ID that has been used in the user login process is automatically designated. The controller 202 of the image forming apparatus 102 confirms a user group including the login user through the login ID of the user in operation 604. The following embodiment exemplarily assumes that the user group of the login user is set to “BOTH” for convenience of description and better understanding, and a detailed description thereof will hereinafter be given. Since the login user belongs to the user group denoted by “BOTH”, the image forming apparatus 102 has to display the user scan profile of the login user and the administrator scan profile of the image forming apparatus 102 such that the displayed profiles can be visually recognized by the login user. For this operation, the controller 202 of the image forming apparatus 102 requests the user scan profile of the login user from the user computer 106 in operation 606. Upon receiving a request for the user scan profile, the user computer 106 transmits the corresponding user scan profile to the image forming apparatus 102 in operation 608. The image forming apparatus 102 displays both the user scan profile received from the user computer 106 and the administrator scan profile of the image forming apparatus 102, so that the login user can visually recognize the displayed profiles in operation 610. The login user, who views the user scan profile and the administrator scan profile that are displayed on the image forming apparatus 102, selects a scan profile to obtain his or her desired scanning result, and the controller 202 of the image forming apparatus 102 receives the selection signal in operation 612. The controller 202 of the image forming apparatus 102 transmits a user-selected scan profile to the user computer in operation 614. The user computer 106 receives and stores the user-selected scan profile, and requests the scanning process using the stored scan profile from the image forming apparatus 102 in operation 616. The controller 202 of the image forming apparatus 102 performs the scanning process according to the option defined in the corresponding scan profile, and transmits the scanning result to the user computer 106 decided by the user, so that the scanning result can be stored in the storage unit 260 of the user computer 106 in operation 618.

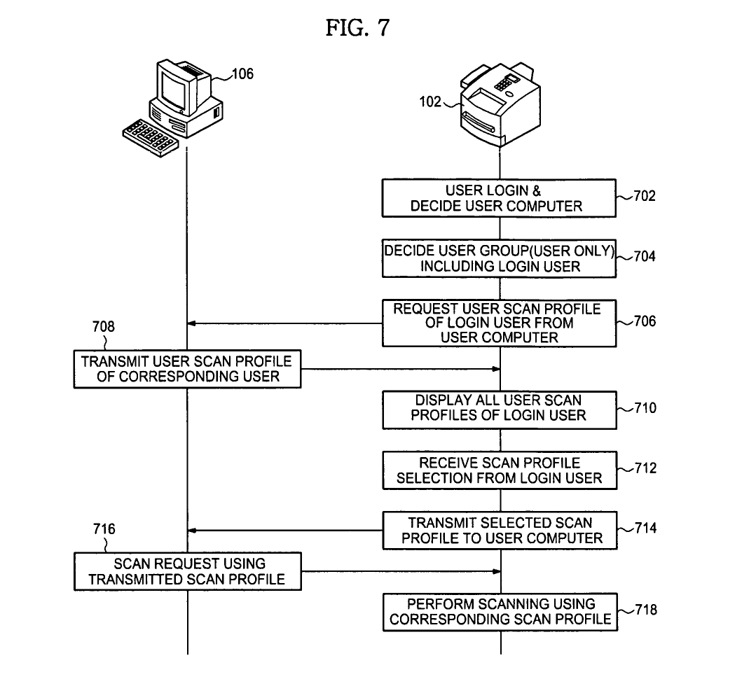

FIG. 7 is a flowchart illustrating another scanning method based on a user policy according to one embodiment. In more detail, FIG. 7 shows a scanning method executed in the image forming apparatus 102 upon receiving a request from the user contained in the user group denoted by “USER ONLY”. In FIG. 7, the user computer 106 stores at least one user scan profile, at least one user computer and at least one user are registered in the image forming apparatus 102, and a user group for the user is preset (See FIGS. 3 and 4). In order to enable the user to perform the scanning process using the image forming apparatus 102, the user has to log in to the image forming apparatus 102 through his or her login ID in operation 702. When the user logs in, the user determines a desired user computer 106 to which the scanning result is to be transmitted and stored. If the user does not determine a desired user computer, the user computer 106 related to an ID that has been used in the user login process is automatically designated. The controller 202 of the image forming apparatus 102 confirms a user group including the login user through the login ID of the user in operation 704. The following embodiment exemplarily assumes that the user group of the login user is set to “USER ONLY” for convenience of description and better understanding, and a detailed description thereof will hereinafter be as follows. Since the login user belongs to the user group denoted by “USER ONLY”, the image forming apparatus 102 has to display only the user scan profile of the login user such that the displayed profile can be visually recognized by the login user. For this operation, the controller 202 of the image forming apparatus 102 requests the user scan profile of the login user from the user computer 106 in operation 706. Upon receiving a request for the user scan profile, the user computer 106 transmits the corresponding user scan profile to the image forming apparatus 102 in operation 708. The image forming apparatus 102 displays the user scan profile received from the user computer 106, so that the login user can visually recognize the displayed profile in operation 710. The login user, who views the user scan profile displayed on the image forming apparatus 102, selects a scan profile needed for obtaining his or her desired scanning result, and the controller 202 of the image forming apparatus 102 receives this selection signal in operation 712. The controller 202 of the image forming apparatus 102 transmits a user-selected scan profile to the user computer in operation 714. The user computer 106 receives and stores the user-selected scan profile, and requests the scanning process using the stored scan profile from the image forming apparatus 102 in operation 716. The controller 202 of the image forming apparatus 102 performs the scanning process according to the corresponding scan profile, and transmits the scanning result to the user computer 106 decided by the user, so that the scanning result can be stored in the storage unit 260 of the user computer 106 in operation 718.

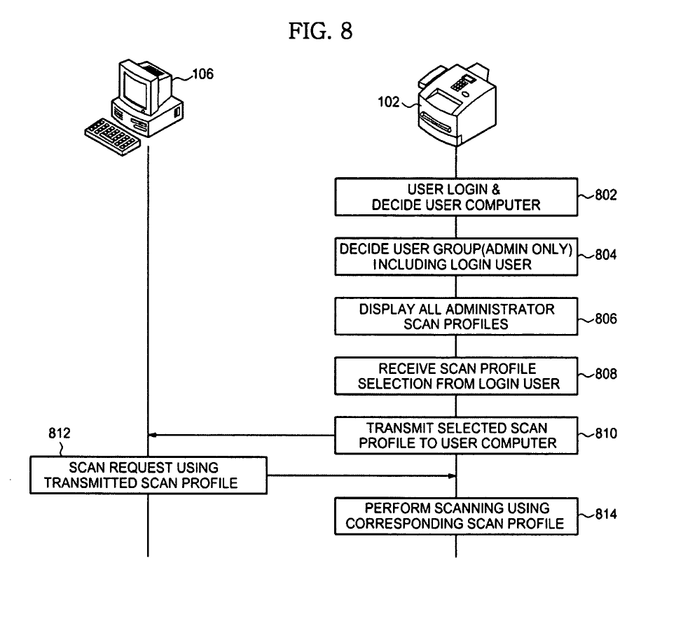

FIG. 8 is a flowchart illustrating still another scanning method based on a user policy according to one embodiment. In more detail, FIG. 8 shows a scanning method executed in the image forming apparatus 102 upon receiving a request from the user contained in the user group denoted by “ADMIN ONLY”. In FIG. 8, the user computer 106 stores at least one user scan profile, at least one user computer and at least one user are registered in the image forming apparatus 102, and a user group for the user is preset (See FIGS. 3 and 4). In order to enable the user to perform the scanning process using the image forming apparatus 102, the user has to log in to the image forming apparatus 102 using his or her login ID in operation 802. When the user logs in, the user determines a desired user computer 106 to which the scanning result is to be transmitted and stored. If the user does not determine a desired user computer, the user computer 106 related to an ID that has been used in the user login process is automatically designated. The controller 202 of the image forming apparatus 102 confirms a user group including the login user through the login ID of the user in operation 804. The following embodiment exemplarily assumes that the user group of the login user is set to “ADMIN ONLY” for convenience of description and better understanding of embodiments, and a detailed description thereof will hereinafter be given. Since the login user belongs to the user group denoted by “ADMIN ONLY”, the image forming apparatus 102 has to display only the administrator scan profile such that the displayed profile can be visually recognized by the login user. For this operation, the image forming apparatus 102 of the image forming apparatus 102 displays the administrator scan profile stored in the storage unit 214 of the image forming apparatus 102, so that the login user can visually recognize the displayed profile in operation 806. The login user, who views the administrator scan profile displayed on the image forming apparatus 102, selects a scan profile to obtain his or her desired scanning result, and the controller 202 of the image forming apparatus 102 receives this selection signal in operation 808. The controller 202 of the image forming apparatus 102 transmits a user-selected scan profile to the user computer in operation 810. The user computer 106 receives and stores the user-selected scan profile, and requests the scanning process using the stored scan profile from the image forming apparatus 102 in operation 812. The controller 202 of the image forming apparatus 102 performs the scanning process according to the option defined in the corresponding scan profile, and transmits the scanning result to the user computer 106 decided by the user, so that the scanning result can be stored in the storage unit 260 of the user computer 106 in operation 814.

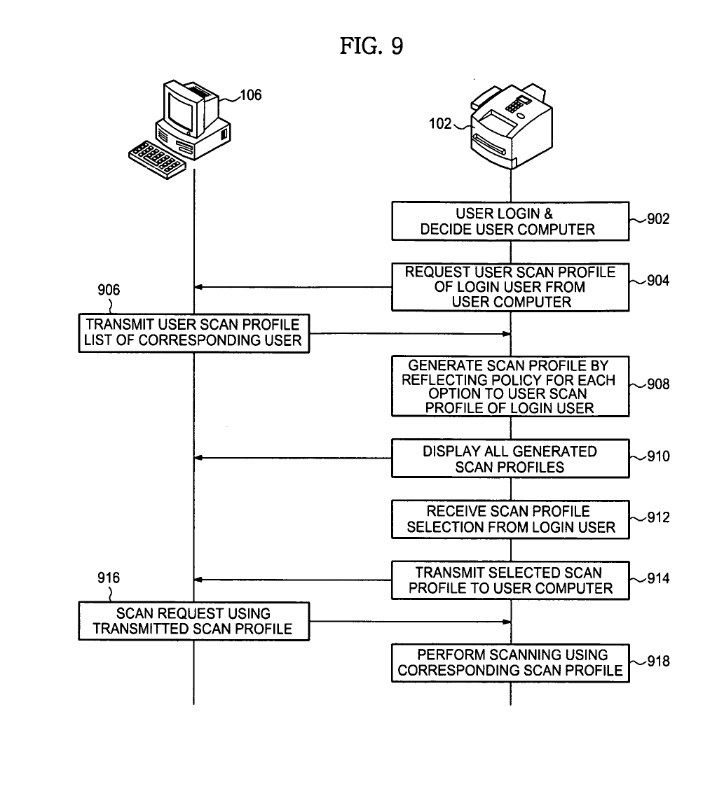

FIG. 9 is a flowchart illustrating a scanning method according to an embodiment. In more detail, FIG. 9 is a flowchart illustrating a scanning method executed in the image forming apparatus 102 by reflecting a policy for each option to the user scan profile. In FIG. 9, the user computer 106 stores at least one user scan profile, and the image forming apparatus 102 stores at least one administrator scan profile (See FIGS. 3 and 4). In order to enable the user to perform the scanning process using the image forming apparatus 102, the user has to log in to the image forming apparatus 102 using his or her login ID in operation 902. When the user logs in, the user determines a desired user computer 106 to which the scanning result is to be transmitted and stored. If the user does not select a computer, the user computer 106 related to an ID that has been used in the user login process is automatically designated. The controller 202 of the image forming apparatus 102 requests the user scan profile of the login user from the user computer 106 in operation 904. Upon receiving the request of the user scan profile, the user computer 106 transmits the corresponding user scan profile to the image forming apparatus 102 in operation 906. The image forming apparatus 102 reflects the policy for each option to the user scan profile received from the user computer 106, so that it generates a new scan profile in operation 908. That is, it is determined whether a unique option for the user scan profile will be reflected in each option prescribed in the scan profile or will be replaced with an administrator mandatory option, such that the image forming apparatus 102 generates a new scan profile by reflecting the determined result. For this operation, the policies for individual options are pre-stored in the image forming apparatus 102, such that the controller 202 can refer to the policies upon receiving a scanning request from the user. The controller 202 of the image forming apparatus 102 displays all the newly generated scan profiles, and enables the login user to visually recognize the displayed scan profiles in operation 910. The login user, who views the new scan profile (to which the policy for each option is reflected) displayed on the image forming apparatus 102, selects a scan profile according to his or her desired scanning result, and the controller 202 of the image forming apparatus 102 receives this selection signal in operation 912. The controller 202 of the image forming apparatus 102 transmits a user-selected scan profile to the user computer in operation 914. The user computer 106 receives and stores the user-selected scan profile, and requests the scanning process using the stored scan profile from the image forming apparatus 102 in operation 916. The controller 202 of the image forming apparatus 102 performs the scanning process according to options set in the corresponding scan profile, and transmits the scanning result to the user computer 106 decided by the user, so that the scanning result can be stored in the storage unit 260 of the user computer 106 in operation 918.

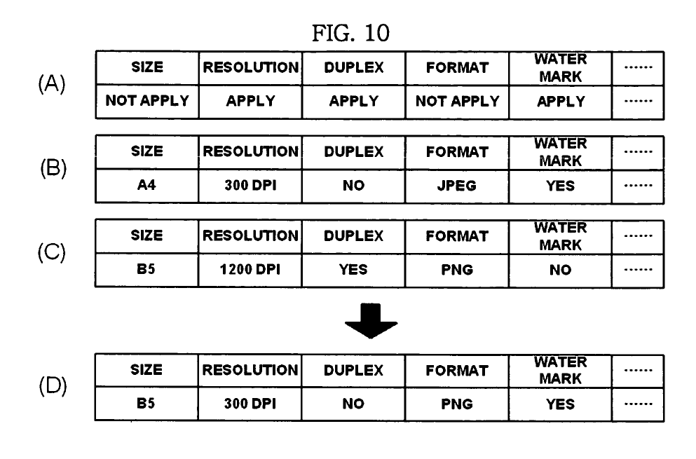

FIG. 10 is a conceptual diagram illustrating a method for generating a new modified scan profile by reflecting a scan profile policy for each option to a user scan profile according to one embodiment. FIG. 10 shows a detailed description of the operation 908 of FIG. 9. In FIG. 10, (A) is a scan profile policy for each option pre-stored in the image forming apparatus 102, (B) is an administrator scan profile, (C) is a user scan profile, and (D) is a new scan profile to which the scan profile policy for each option is reflected. All the scan profiles shown in FIG. 10 include a variety of option values, for example, <SIZE> indicating an image size, <RESOLUTION> indicating an image resolution, <DUPLEX> indicating double-sided scanning, <FORMAT> indicating an image format, <WATERMARK> indicating watermark insertion. In this case, <WATERMARK> is an option for determining whether a watermark for security is to be inserted into the scan result. For reference, in FIG. 10, an option value “NO” of <DUPLEX> indicates no execution of double-sided scanning, and another value “YES” of <DUPELX> indicates the execution of double-sided scanning. An option value “NO” of <WATERMARK> indicates that the watermark is not inserted, and another option value “YES” of <WATERMARK> indicates that the watermark is inserted.

Referring to the scan profile policies for individual options shown in FIG. 10(A), each of <SIZE> and <FORMAT> has an option value “NOT APPLY”, and each of <RESOLUTION> and <DUPLEX>, and <WATERMARK> has another option value “APPLY”. In this case, “NOT APPLY” indicates that the corresponding option ignores the option value of the administrator scan profile and maintains the option value of the user scan profile without any change, and “APPLY” indicates that the option value of the user scan profile is replaced with the option value of the administrator scan profile.

For example, according to the scan profile policy for each option shown in FIG. 10(A), the corresponding option values of the administrator scan profile are not reflected to <SIZE> and <FORMAT> each of which is denoted by “NOT APPLY”, so that <SIZE> and <FORMAT> of the new scan profile shown in FIG. 10(D) respectively maintain “B5” and “PNG” indicating option values of the user scan profile. In contrast, according to the scan profile policy for each option shown in FIG. 10(A), the corresponding option values of the administrator scan profile are reflected to <RESOLUTION>, <DUPLEX> and <WATERMARK>, each of which is denoted by “APPLY”, so that <RESOLUTION>, <DUPLEX>, and <WATERMARK> of the new scan profile shown in FIG. 10(D) are respectively changed to “300 DPI”, “NO”, and “YES” indicating option values of the administrator option profile. Likewise, some option values are changed by reflecting the administrator scan profile policy to the user scan profile, and the changed option values are applied to the image forming apparatus. As a result, although the option value of the user profile escapes from a predetermined range of functions provided from the image forming apparatus 102, the image forming apparatus according to one or more embodiments can adjust the escaped option value to enter the predetermined range, and can prevent problems encountered by selecting wrong option values. Specifically, the image forming apparatus according to one or more embodiments can apply a high security level to some users, so that fraudulent or illegal use of the image forming apparatus by unauthorized users is prevented.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such are read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate ARRAY (FPGA), which executes program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice-versa.

As is apparent from the above description, the image forming apparatus and a method for controlling the same according to embodiments generate an administrator scan profile through an input unit mounted to the image forming apparatus, and establish a scan profile policy, such that the administrator of the image forming apparatus can provide a specific scan profile policy to all users sharing the image forming apparatus.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. An image forming apparatus comprising:
an input unit to perform at least one of generation of a first scan profile and establishment of a scan profile policy; and
a controller to perform a scanning operation according to at least one of the first scan profile and the scan profile policy.

2. The image forming apparatus according to claim 1, further comprising:
a display to display at least one allowed scan profile for a user according to the scan profile policy.

3. The image forming apparatus according to claim 2, further comprising:
a selection unit to select at least one allowed scan profile displayed on the display.

4. The image forming apparatus according to claim 1, wherein the first scan profile is an administrator scan profile.

5. The image forming apparatus according to claim 1, wherein the image forming apparatus is connected to at least one user computer over a network.

6. The image forming apparatus according to claim 1, wherein the scan profile policy includes a scan profile policy for each user so as to provide different kinds of scan profiles according to authority assigned to each login ID.

7. The image forming apparatus according to claim 6, wherein the scan profile policy provides one or both of a user scan profile and an administrator scan profile according to authority assigned to the login ID.

8. The image forming apparatus according to claim 1, wherein the scan profile policy includes a scan profile policy for each option, so as to provide different option values of the scan profile according to authority assigned to each login ID.

9. The image forming apparatus according to claim 1, wherein the image forming apparatus supports a Scan-To-PC scheme.

10. The image forming apparatus according to claim 1, wherein the input unit includes a plurality of keys.

11. The image forming apparatus according to claim 1, wherein the input unit is implemented as a graphical user interface (GUI) displayed on a touch panel.

12. The image forming apparatus according to claim 1, wherein the input unit is an Embedded Web Server (EWS).

13. A method for controlling an image forming apparatus which includes an input unit to perform at least one of generation of a first scan profile and establishment of a scan profile policy and a controller to perform a scanning operation according to at least one of the first scan profile and the scan profile policy, and is connected to at least one user computer over a network, the method comprising:
determining whether a user logs in to the image forming apparatus;
displaying, if the user logs in to the image forming apparatus, only one or more scan profiles allowed for a login ID of the user; and
upon receiving a signal for selecting at least one scan profile allowed for the login ID, performing a scanning process using the selected scan profile.

14. The method according to claim 13, wherein the at least one scan profile allowed for the login ID is determined according to the scan profile policy related to the login ID.

15. The method according to claim 14, wherein the scan profile policy includes a scan profile policy for each user so as to provide different kinds of scan profiles according to authority assigned to each login ID.

16. The method according to claim 14, wherein the scan profile policy provides one or both of a user scan profile and an administrator scan profile according to authority assigned to the login ID.

17. The method according to claim 14, wherein the scan profile policy includes a scan profile policy for each option, so as to provide different option values of the scan profile according to authority assigned to each login ID.

18. The method according to claim 13, further comprising:
upon receiving the signal for selecting the scan profile, transmitting the selected scan profile to a user computer coupled to the image forming apparatus; and
receiving a scan request using the selected scan profile from the user computer.

19. The method according to claim 18, further comprising:
after completion of the scanning process, transmitting the result of the scanning process to the user computer.

20. The method according to claim 13, wherein the image forming apparatus supports a Scan-To-PC scheme.
